(19) United States
(12) Patent Application Publication
(10) Pub. No.: US 2012/0171347 A1
(43) Pub. Date: Jul. 5, 2012

(54) FOOD PRECURSOR COMPOSITION METHOD FOR ITS PRODUCTION AND USES THEREOF

(75) Inventor: Ole Kristian STEINBEKKEN, Slastad (NO)

(73) Assignee: Tine BA, Oslo (NO)

(21) Appl. No.: 13/419,076

(22) Filed: Mar. 13, 2012

Related U.S. Application Data
(62) Division of application No. 11/995,587, filed on Aug. 18, 2008.

(30) Foreign Application Priority Data
Jul. 15, 2005 (NO) 20053469

(51) Int. Cl. A21D 10/04

(52) U.S. Cl. 426/558

(57) ABSTRACT

There is disclosed a fluid or semi-fluid ready-to-use food precursor product being suitable for producing sauces, thickenings or pastry such as waffles, pancakes, muffins, sugar bread etc. The food precursor composition has improved storage stability and provides an improved end product as compared to corresponding known compositions. There is also disclosed a process for producing such food precursor products.

This application is a division of U.S. patent application Ser. No. 11/995,587 filed Aug. 18, 2008 entitled “Food Precursor Composition, Method for its Production and Uses” which is a 371 of International Application PCT/NO2006/000278 filed Jul. 14, 2006 and claims priority benefits to Norwegian Application 2005 3469 filed Jul. 15, 2005, all disclosures of which are herein incorporated by reference.

The present invention concerns a food precursor composition, a process for the production of the precursor food composition and uses of such a preparation. The invention concerns especially a fluid to semi-fluid preparation which is suitable for making flour food products such as waffles, pancakes, muffins, sugar bread, sponge cake, pre-made layers for layer-cake, etc., but which is also suitable for making sauces and thickeners and wherein the swelling properties of the flour has been maintained in the semi-liquid or liquid preparation.

### BACKGROUND FOR THE INVENTION

There is previously known preparations which are meant as a basis for producing flour products like the ones mentioned supra. Mainly such preparations are offered as dry matter compositions since it previously has been problematic to produce such fluid products being storage stable, not being the subject of relatively fast quality reduction in the form of e.g. separation, oxidation and/or rancidifaction, and which additionally provide tasteful and appealing end products. Additionally, especially fluid or liquid food compositions to a larger extent than dry matter compositions will be subjected to bacteria, mould or fungus attacks, which very easily may lead to destruction of the composition.

Dry matter compositions have few or none of these drawbacks, but it is necessary to add to dry matter compositions fluids or liquids in the form of milk, water, butter/fat [liquid or melted] etc., something which in some cases is unavailable (e.g. when camping if the water quality at any given location is poor and it is far to the nearest food store, etc.). Furthermore, the addition of fluids/liquids will open for erroneous measurements (it is added e.g. too much fluid/liquid so that it becomes impossible to make the relevant product with the erroneously measured batter), and when the relevant compositions have been made from the dry matter mixtures, they ought to be used within a short time since the final batter is the subject of quality reduction in the form of such reactions and microorganism attacks as indicated supra.

Also, dry matter compositions require mixing with liquids in a suitable bowl or receptacle by the final user. This represents a further inconvenience since the mixing tools as well as the receptacle(s) will have to be cleaned after use, and this is in many cases, such as when camping, very inconvenient and laborious. With a ready made batter (pancake, waffle, muffins, etc.) it is possible to avoid using receptacles, bowls and tools altogether, since it will be possible to pour the batter directly into e.g. the frying pan or the waffle iron. This thus represents a further progress within the art and an advantage of the food precursor composition according to the present invention.

Thus there is a need for storage stable and fluid/liquid ready-made food precursor materials providing tasteful and appealing end products of the type being indicated supra.

In the present disclosure the expression “a fluid or liquid food precursor composition” is used. One of the purposes behind using this expression is to indicate that the compositions according to the present invention are to be used as an intermediate product for making the final end food product. The batter/composition according to the present invention thus is made of original food products (e.g. milk, eggs, sugar, flour, butter, etc.), but is not meant to be consumed as such, but is meant to be further processed (e.g. by frying, heating, etc.) to the final end product (e.g. waffles, pancakes, gravy, sauces,

Also, it is to be remarked, with respect to the present invention, that it should be distinguished between dough and batter where the former has a much more solid structure (e.g. for making bread) and the latter is quite fluid/liquid with flowing properties. In this respect the water activity of the product is to be noted. Also, the presence and amount of the ingredients has an impact on the final properties of the end product. For instance, the presence of butter or the swelling properties of the flour or batter influences the properties of the end product. This may be observed by comparing end products such as Belgian waffles as compared to French waffles, where the former are thick, crispy and fluffy, whereas the latter are thin and soft. The same is relevant for e.g. pancakes.

### PRIOR ART

From U.S. Pat. No. 3,970,763 it is known a type of batter which is suitable for a cake mix to be used to make Victoria sandwich or pound cake. Such a batter is rather firm (like batter for doughnuts), and has poor flowing properties. It is not suitable as a composition for waffles or pancakes. Additionally, a batter according to this prior art has a low water activity (below 85%) [the water activity being defined as a number between 1.00 for pure water and 0.00 for a completely dry substance, the water activity (aw) being defined by the equation aw=P/PO=HER/100 wherein P=the partial vapor pressure of water in a food sample at a temperature T; PO=the saturation vapor pressure of pure water at a temperature T; HER=relative humidity at a temperature T (equilibrium relative humidity)]. Also, when producing this type of batter, it is included a swelling substance (baking powder). This is to ensure the swelling of the final product, whereas, according to the present invention, it is preferred to rely on the swelling properties of the flour itself, and also to add an inert gas into the batter to ensure swelling that way. Also a batter according to this prior art is added a stiffening agent (e.g. gelatin), and a storage time is indicated to stiffen or set the mix, thus reducing its flowability.

From WO 2004/107866 it is known a liquid dough (batter) with a water activity (Aw) of less than 0.9 (90%). The pastry to be made from this type of dough is also indicated to be solid cakes (e.g. fruit cake, snack or stuffed bread), and not softer types of products such as waffles, pancakes, gravy or sauces. Also for reducing the water activity of the batter to below the indicated value of 90% it is indicated in this prior art to include carbohydrates and additionally it is added fat in an amount of from 20% to 30% which makes a rather heavy dough with respect to its content of lipids, i.e. its high fat content.

From EP patent 1 532 862 it is known a liquid batter for preparing pancakes, waffles, brownies, muffins etc. with a water activity above 95% forming a flowable product To stabilize such a batter it is indicated that it be heat-treated at a temperature within the interval from 60° C. to 72° C., preferably at 67° C. A drawback of heating such a batter to the high temperature range of 72° is that although this temperature allows the batter to be homogenized, the eggs in the batter will congeal, and no remedy is mentioned for this problem (except the addition of an external preservative such as an organic acid, e.g. malic acid and/or potassium sorbate). Although it will be possible to make pancakes with such a batter as this one, the pancakes will be brittle and thick, and they will be rather bland in their taste on account of the missing sugar in the batter.

There is thus room for a liquid batter of the kind disclosed according to the present invention, which has a water activity of more than 95%, which includes eggs and sugar (in addition to the other ingredients disclosed infra), where the inclusion of sugar makes it possible to heat the egg fraction to 72° C. without the eggs congealing in the process. Also the liquid batter according to the present invention will form a batter that will swell without any external swelling agent having been added to the batter (this is, however, not saying that it is not possible to optionally add external swelling agent to the present batter).

Thus there exists a need for a storage-stable and liquid pre-made food precursor composition providing tasteful and appealing end products of the type mentioned supra, and which additionally provides a ready-to-use batter which avoids the inconvenience with tools and utensils that have to be cleaned after use.

### GENERAL DISCLOSURE OF THE INVENTION

According to the present invention there is provided a liquid/semi-liquid food precursor product comprising a part of polysaccharides giving the product consistency and additionally providing the product with a swellability when fried. Relevant polysaccharides will be starch (e.g. from cereals in the form of wheat, barley, rye, potato, corn (maize), tapioca and corresponding flour compositions), dextrins, guar gums, xanthan gums, LGB (“Locust Bean Gum”), carrageenan etc. The relevant polysaccharides will preferably be water-soluble. The polysaccharide part of the food precursor product according to the invention will lie within the ^{interval} 3-50%, more preferred 10-50%, even more preferred 30-45%, most preferred 35-42%, especially 38-40% calculated from the weight of the end product. The indicated percentages of polysaccharide will depend on what kind of end product that is to be produced, since e.g. batters normally will contain more polysaccharides (starch, flour) than e.g. sauces/gravy and thickeners. Determination of the exact amount of polysaccharide may be done by the person skilled in the art without any extensive experimentation.

In connection with the expression “polysaccharide” supra this expression includes, in relation to the present invention, also the relevant flour products, since flour is such a natural polysaccharide source, but which also comprises a number of other substances such as inter alia proteins and mono- and oligosaccharides as well as vegetable fat etc. in smaller amounts. Such flour products are also included in the scope of the present invention. The amount of the flour product will then also lie within the interval 25-50%, preferred 30-45%, most preferred 35-42%, especially 38-40% calculated on the basis of the weight of the end product.

In connection with the precursor food product according to the present invention, there may alternatively be used a flour or starch product without gluten, with a reduced content of gluten or where the gluten has been removed to produce a product being suitable for persons with gluten allergy or with gluten sensitivity.

The part of “polysaccharide” (starch/flour product) in the end product according to the invention, does not in this connection include mono-, di- or oligosaccharides that are added the end product as sweeteners (see infra).

The food precursor product according to the present invention furthermore comprises edible fat/oil in the form of fatty acids with a chain length of 8-40 C-atoms, more preferred 10-35 C-atoms, especially 15-30 C-atoms. As examples of such types of fat/oil there may be mentioned stearic acid, palmitic acid, but also natural fat/oil compositions comprising vegetable and/or animal fat/oils such as butter oil, however preferred are vegetable fats/oils or fat/oil compositions such as soy oil, rape oil, olive oil, linen-seed oil, sunflower oil etc. Such fat/oil types may also be hydrogenated/hardened fats/oils.

The fat/oil types that are used in the present invention may be saturated on unsaturated ones. It will also be possible to include or add fish oils or fish oil products such as omega-3 fatty acids or derivatives thereof, e.g. hardened or de-flavored derivatives thereof. An example of usable oil from fish is natural or processed (e.g. de-odorized) cod liver oil. Alternatively, also non-caloric fats may be included in the product according to the present invention.

The fat/oil types to be used in the present invention may be both saturated and non-saturated ones. The selection of the type of fat/oil will also depend on the wanted taste of the end product, and may easily be determined based on the knowledge of the person skilled in the art. The ratio of the fat/oil part of the end product according to the invention will normally lie within the interval 3-20%, more preferred 5-15%, even more preferred 7-13%, e.g. 8% calculated from the weight of the end product. This makes the product according to the present invention a much leaner product than the products according to the prior art.

By “fat” it is in the present circumstances meant added fat/oil, and it is in this connection not included fat that optionally is added through the milk product. If there is added fat, the total amount of fat in the end product according to the invention, will increase accordingly.

Furthermore, the food precursor product according to the present invention may comprise proteins in the form of eggs and/or egg fractions. Eggs will, in the present connection, in addition to conveying taste and consistency to the end product, also function as a stabilizer/emulgator. Phospholipids may inter alfa possess this function. Especially components such as lecithin will be particularly suited as an ingredient in the food precursor product according to the invention. Eggs or egg products may also be present in the form of a dry product, and it may also be used egg fractions such as added egg white or yolk, all based on the wanted taste and consistency of the final food product. The selection of the amount of eggs and/or egg fractions may easily be determined by the person skilled in the art based on the present disclosure. The amount of eggs in the end product according to the invention will normally lie within the interval up to 15%, preferred 5-10%, e.g. 8% calculated on the basis the weight of the end product.

The addition of eggs to the composition according to the present invention is preferably, but not exclusively done through the addition of heat treated (pasteurized) eggs or egg fractions. In this connection it is noteworthy that the addition of sugars (e.g. glucose, sucrose, mannose, maltose, fructose etc.) will provide an opportunity to heat the egg fraction to above 72° C. without coagulating or congealing the eggs. This is advantageous since egg proteins are required to form a binding matrix when the batter subsequently is fried or heated making it possible to form a batter which may be pasteurized at high temperatures without the risk of the batter congealing, and still obtain a fluid/liquid batter (e.g. for pancakes or waffles).

A food precursor product according to the present invention may alternatively be produced without egg proteins for providing a product being suitable for persons with egg allergies.

Consequently, according to the present invention it may additionally be produced a special food precursor product without any egg proteins or gluten being suitable for persons with allergies. The raw materials in such a product may then be different types of starches (see supra) providing the wanted consistency to the food precursor product and the end product in addition to fat/oil, sugar, taste additives and stabilizers.

Finally, the food precursor product according to the invention comprises fluid in the form of water or milk. Preferred it is used milk in the form of whole milk or processed milk such as milk powder added water in the prescribed amount, light milk, skimmed milk, etc. Milk, milk products or and/or water makes up the liquid portion of the product according to the invention, and it is present in addition to the dry parts of the end product so that the amount reaches 100% (calculated on the weight of the end product). As mentioned supra, if there are used fluid fats (e.g. marine (omega-3) oil, animal oil or plant oil), this fraction will be calculated into the lipid (fat/oil) fraction, but the consistency of the fat fraction will of course influence the liquidity of the final product. A measurement of the amount of fluid to be present in the batter according to the invention, is the water activity of the batter, as mentioned supra.

In the product according to the invention there may also be used lactose-reduced milk so that also lactose-intolerant persons may accept the product. A treated milk portion wherein the milk proteins which may cause allergic reactions have been reduced or removed may also be used for producing a product being suitable for persons with milk allergy. In the food precursor product according to the present invention, there may, as the liquid portion, also be used another kind of fluid than conventional or processed cow's milk, e.g. water, coco milk, soy milk etc, or alternatively or additionally milk from other animals, e.g. goat. If special types of tastes are to be obtained in the product produced from the food precursor composition according to the present invention, also other types of liquid such as juices, wine, plant extracts, cognac or whiskey extracts, etc. may be used as part or the complete liquid portion of the product according to the invention. Still the liquid portion of the food precursor composition according to the invention will have to be present in an amount sufficient to obtain a water activity in the product of 95% or more.

In connection with the liquid part of the food precursor product according to the invention, it shall be mentioned that the end product also may comprise extra ingredients in the form of surfactants, stabilizers, taste enhancers, sweeteners, salt, color and other additives in a total amount from 0% up to 5% (calculated on the weight of the end product). Such extra ingredients may also include spices/taste enhancers such as nutmeg, vanilla, cinnamon, salt, barbecue seasoning, etc. (depending on the wanted taste and use of the end product, e.g. in the case of pancakes if the pancakes are to be used as a dessert or as a dinner meal).

As a sweetener there may be used sugar (glucose, fructose, maltose, etc. or mixtures thereof) or artificial sweeteners e.g. saccharose, sorbitol, aspartame, etc. for optionally producing a product also suited for e.g. diabetics.

Examples of the food precursor product according to the invention follow infra:

### EXAMPLE 1

Waffle Batter:

Embodiment I
Mixture ratio flour/milk

| | | | | | | | 40.00% | 50.81% | 9.19% | | |
|---|---|---|---|---|---|---|---|---|---|---|---|
| | | | | | | | flour | Milk | egg | 100% | |
| Ingredients | Gram | % | KG | % fat | kg fat | % prot | KG PROT | % Carbo | KG Carbo | % water | kgwater |
| Butter oil | 919.9494 | 9.1995 | 0.9199 | 100.000 | 0.920 | 0.000 | 0.000 | 4.700 | | 0 | 0 |
| Vegetable oil | 459.9747 | 4.5997 | 0.4600 | 100.000 | 0.460 | 0.000 | 0.000 | 0.000 | 0 | 0 | 0 |
| Whole egg mass | 799.9972 | 8.0000 | 0.8000 | 10.250 | 0.082 | 45.000 | 0.360 | 3.000 | 0.024 | 4 | 0.032 |
| Wheat flour 78% | 2019.8889 | 20.1989 | 2.0199 | 2.500 | 0.050 | 11.100 | 0.224 | 70.000 | 1.41392 | 15 | 0.30298 |
| Novation 2700 (starch) | 599.9670 | 5.9997 | 0.6000 | 0.100 | 0.001 | 0.000 | 0.000 | 0.000 | 0 | 10 | 0.06 |
| Skimmed milk | 4661.3094 | 46.6131 | 4.6613 | 3.900 | 0.182 | 3.300 | 0.154 | 4.800 | 0.22374 | 87 | 4.05534 |
| Sugar in eggs | 91.9220 | 0.9192 | 0.0919 | 0.000 | 0.000 | 0.000 | 0.000 | 100.000 | 0.09192 | 0 | 0 |
| Sugar in milk | 406.4800 | 4.0648 | 0.4065 | 0.000 | 0.000 | 0.000 | 0.000 | 100.000 | 0.40648 | 0 | 0 |
| Freemulsion KN | 8.1296 | 0.0813 | 0.0081 | | 0.000 | | 0.000 | 100.000 | 0.00813 | | 0 |
| Vanilla, Danisco U 35636 | 5.0810 | 0.0508 | 0.0051 | 0.000 | 0.000 | 0.000 | 0.000 | 0.000 | 0 | 99 | 0.00503 |
| Salt | 27.3008 | 0.2730 | 0.0273 | 0.000 | 0.000 | 0.000 | 0.000 | 0.000 | 0 | 0 | 0 |
| Total | 10000.0000 | 100.0000 | 10.0000 | 16.948 | 1.695 | 7.380 | 0.738 | 21.682 | 2.1682 | 44.553 | 4.45535 |

| | |
|---|---|
| Purpose of the experiment | 55.8126% milk products |

Flour portion

| | |
|---|---|
| Butter oil | 0.9199 |
| Vegetable oil | 0.4600 |
| Wheat flour, 78% | 2.0199 |
| Novation 2700* (starch) | 0.6000 |
| Sum | 3.998 |

(*“Novation 2700” is a brand name from National Starch, DE)

The milk fraction

| | | |
|---|---|---|
| Sugar | 0.4065 | |
| Skimmed milk | 4.6613 | |
| Freemulsion KN^{♦} (stabilizer) | 0.0081 | Consideration |
| Vanilla, Danisco U 35636 | 0.0051 | Frying time 1.5 min |
| Sum | 5.0810 | |

(^{♦}Commercially available stabilizer from Sesalpinia, IT)

The egg fraction

| | | |
|---|---|---|
| Whole egg mass | 0.8000 | |
| Sugar in eggs | 0.0919 | |
| Salt | 0.0273 | |
| | 0.9192 | |
| Total | 10.0000 | |
| Waffle batter | | Consistency waffle |
| Homogenizer 70/15 bar | | Consistency batter |
| (main pressure/rear pressure) | | |

Process:

The Flour Fraction

The butter oil is melted and heated to 80° C. in a Tetra Albatch processor.

Flour and starch is added (see infra).

After the addition of flour there is added a vacuum of up to 90% and the vacuum pump is switched off. The mixer is activated.

Then the composition is indirectly heated to 110° C. The mixer is run.

The composition is cooled to 50° C. or below. The mixer is active.

The Milk Fraction

UHT-treated directly to 142° C. for 4 sec. (see infra).

Homo 70/15 bar, downstream.

The fraction is cooled to 50° C. or below and drawn into buckets.

The Egg Fraction

The egg fraction is heat treated at 70° C. for 90 sec and is cooled to 50° C. or below

Final Batter

A mix of the correct amount (see infra) of flour-, milk- and egg fractions are mixed in a sterile tank at 50° C.

The final batter is cooled to 4° C.

Finally, the batter is whipped with nitrogen and carbondioxide (see infra).

The final batter may optionally he packed into portion containers or other suitable containers (see infra).

Embodiment II

| | | | | | 1.1 | 1 | | | | | |
|---|---|---|---|---|---|---|---|---|---|---|---|
| Ingredients | Gram | % | KG | % Fat | kg Fat | % PROT | KG PROT | % Carbo | kg Carbo | % Water | kg Water |
| Butter oil | 34500.0000 | 23.0000 | 34.5000 | 100.000 | 34.500 | 0.000 | 0.000 | 4.700 | | 0 | 0 |
| Vegetable oil | 17250.0000 | 11.5000 | 17.2500 | 100.000 | 17.250 | 0.000 | 0.000 | 0.000 | 0 | 0 | 0 |
| Wheat flour, 78% | 75750.0000 | 50.5000 | 75.7500 | 2.500 | 1.894 | 11.100 | 8.408 | 70.000 | 53.025 | 15 | 11.3625 |
| Starch | 22500.0000 | 15.0000 | 22.5000 | 0.000 | 0.000 | 0.000 | 0.000 | 0.000 | 0 | 15 | 3.375 |
| C [symbol] EmTex 06328 | 0.0000 | 0.0000 | 0.0000 | 0.000 | 0.000 | 0.000 | 0.000 | 0.000 | 0 | 15 | 0 |
| Total | 150000.0000 | 100.0000 | 150.0000 | 35.763 | 53.644 | 5.606 | 8.408 | 35.350 | 53.025 | 9.825 | 14.7375 |

[symbol]

indicates data missing or illegible when filed

Embodiment III

| | | | | | 1.1 | 1 | | | | | |
|---|---|---|---|---|---|---|---|---|---|---|---|
| Ingredients | Gram | % | KG | % Fat | kg Fat | % PROT | KG PROT | % Carbo | kg Carbo | % Wate [symbol] | kg Water |
| Dem whey powder | 0.0000 | 0.0000 | 0.0000 | 0.000 | 0.000 | 0.000 | 0.000 | 0.000 | 0 | 2 | 0 |
| Salt | 0.0000 | 0.0000 | 0.0000 | 0.000 | 0.000 | 0.000 | 0.000 | 0.000 | 0 | 0 | 0 |
| Skimmed milk | 18348.0000 | 91.7400 | 18.3480 | 0.100 | 0.018 | 3.300 | 0.605 | 4.800 | 0.8807 | 87 | 15.96 |
| Sugar | 1600.0000 | 8.0000 | 1.6000 | 0.000 | 0.000 | 0.000 | 0.000 | 100.000 | 1.6 | 0 | #REF! |
| Karagenan | 32.0000 | 0.1600 | 0.0320 | | 0.000 | | 0.000 | 100.000 | 0.032 | | 0 |
| Vanilla, Danisco U35636 | 20.0000 | 0.1000 | 0.0200 | 0.000 | 0.000 | 0.000 | 0.000 | 0.000 | 0 | 99 | 0.02 |
| Total | 20000.0000 | 100.0000 | 20.0000 | 0.092 | 0.018 | 3.027 | 0.605 | 12.564 | 2.5127 | #### | #REF! |

[symbol]

indicates data missing or illegible when filed

Embodiment IV
Reduced vanilla

| | | | | | 1.1 | 1 | KG | | | | |
|---|---|---|---|---|---|---|---|---|---|---|---|
| Ingredients | Gram | % | KG | % Fat | kg Fat | % PROT | PROT | % Carbo | kg Carbo | % Water | kg Water |
| Whole egg | 8703.0000 | 87.0300 | 8.7030 | 41.000 | 3.568 | 45.000 | 3.916 | 3.000 | 0.26109 | 4 | 0.34812 |
| Sugar | 1000.0000 | 10.0000 | 1.0000 | 0.000 | | 0.000 | 0000 | 100.000 | 1 | 0 | 0 |
| Salt | 297.0000 | 2.9700 | 0.2970 | 0.000 | 0.000 | 0.000 | 0.000 | 0.000 | 0 | 100 | 0.297 |
| Total | 10000.0000 | 100.0000 | 10.0000 | 35.682 | 3.568 | 39.164 | 3.916 | 12.611 | 1.26109 | 6.451 | 0.64512 |

Whipping of the batter in an aerator

| Gas | N₂ and CO₂ |
|---|---|
| Inlet pressure | 6 bars |
| System pressure | 0.9 bars |
| Rear pressure | 2 bars |
| Flowmeter | 1 |
| Pump | Max |
| Mixer | 600 |
| Overrun | 7.00% |

Embodiment V
Embodiment V
Mixture ratio FLOUR/milk

| | | | | | | | 40.00% | 50.61% | 9.19% | | |
|---|---|---|---|---|---|---|---|---|---|---|---|
| | | | | | | | mel | melk | egg | 100% | KG |
| RAVARE | Gram | % | KG | % FETT | KG FETT | % PROT | KG PROT | % KARB [symbol] | G KARB | % VANN | VANN |
| Smerolje | 9199.4940 | 9.1995 | 9.1995 | 100.000 | 9.199 | 0.000 | 0.000 | 4.700 | | 0 | 0 |
| Vegetabilsk | 4599.7470 | 4.5997 | 4.5997 | 100.000 | 4.600 | 0.000 | 0.000 | 0.000 | 0 | 0 | 0 |
| olje | | | | | | | | | | | |
| heleggmasse | 7999.9717 | 8.0000 | 8.0000 | 10.250 | 0.820 | 45.000 | 3.600 | 3.000 | 0.24 | 4 | 0.32 |
| Hvetemel, | 20198.8890 | 20.1989 | 20.1989 | 2.500 | 0.505 | 11.100 | 2.242 | 70.000 | 14.1392 | 15 | 3.02983 |
| 78% | | | | | | | | | | | |
| Novation | 5999.5700 | 5.9997 | 5.9997 | 0.100 | 0.006 | 0.000 | 0.000 | 0.000 | 0 | 10 | 0.59997 |
| 2700 | | | | | | | | | | | |
| Helmelk | 46577.5270 | 46.5775 | 46.5775 | 3.900 | 1.817 | 3.300 | 1.537 | 4.800 | 2.23572 | 87 | 40.5224 |
| Sukker i egg | 919.2200 | 0.9192 | 0.9192 | 0.000 | 0.000 | 0.000 | 0.000 | 100.000 | 0.91922 | 0 | 0 |
| Sukker | 4064.8000 | 4.0648 | 4.0646 | 0.000 | 0.000 | 0.000 | 0.000 | 100.000 | 4.0648 | 0 | 0 |
| i melk | | | | | | | | | | | |
| Frimulsjon | 116.8630 | 0.1169 | 0.1169 | | 0.000 | | 0.000 | 100.000 | 0.11656 | | 0 |
| KN | | | | | | | | | | | |
| Vanilje, | 50.8100 | 0.0508 | 0.0506 | 0.000 | 0.000 | 0.000 | 0.000 | 0.000 | 0 | 99 | 0.0503 |
| Danisco | | | | | | | | | | | |
| U 35636 | | | | | | | | | | | |
| Salt | 273.0083 | 0.2730 | 0.2730 | 0.000 | 0.000 | 0.000 | 0.000 | 0.000 | 0 | 0 | 0 |
| Totalt | 100000.0000 | 100.0000 | 100.0000 | 16.947 | 16.947 | 7.379 | 7.379 | 21.716 | 21.7158 | 44.523 | 44.5225 |

[symbol]

indicates data missing or illegible when filed

| | |
|---|---|
| Purpose of the experiment | 55.7770% milk products |

Flour fraction

| | |
|---|---|
| Butter oil | 9.1995 |
| Vegetable oil | 4.5997 |
| Wheat flour, 78% | 20.1989 |
| Novation 2700* (starch) | 5.9997 |
| Sum | 39.9978 |

(*“Novation 2700” is a brand name from National Starch, DE)

The milk fraction

| | | |
|---|---|---|
| Sugar | 4.0648 | |
| Whole milk | 46.5775 | |
| Freemulsion KN^{♦} (stabilizer) | 0.1169 | Consideration |
| Vanilla, Danisco U 35636 | 0.0508 | Frying time 1.5 min |
| Sum | 50.8100 | |

(^{♦}Commercially available stabilizer from Sesalpinia, IT)

The egg fraction

| | | |
|---|---|---|
| Whole egg mass | 8.0000 | |
| Sugar in eggs | 0.9192 | |
| Salt | 0.2730 | |
| | 9.1922 | |
| Total | 100.0000 | Consistency waffle |
| Homogenizer 70/15 bar | | Consistency batter |
| (main pressure/rear pressure) | | |

Process:

The butter oil is melted and heated to 80° C. in a Tetra Albatch processor.

Flour and starch is added (see infra).

After the addition of flour there is added a vacuum of up to 50% and the vacuum pump is deactivated. The mixer is activated.

The composition is then indirectly heated to 10° C. The mixer is run with the knives at half speed and at the lowest level.

The mixture is cooled to 50° C. or below. The mixer and knives are active.

The Milk Fraction

UHT-treated directly to 142° C. for 4 sec.

Homo 70/15 bar, downstream

The mixture is cooled to 50° C. or below (ambient temperatures) and drawn into buckets.

Final Batter

The correct amount of flour fraction (see infra) is added to a sterile tank at 50° C.

The correct amounts of egg and milk fractions are added.

Cooling to 4° C.

Whipping with nitrogen.

### EXAMPLE 2

Waffle Batter:

Embodiment VI
Mixture ratio flour/milk

| | | | | | | | 38.00% | 52.81% | 9.19% | | |
|---|---|---|---|---|---|---|---|---|---|---|---|
| | | | | | | | Mel | melk | egg | 100% | |
| Ingredients | Gram | % | KG | % Fat | kg Fat | % PROT | KG PROT | % Carbo | kg Carbo | % Water | kg Water |
| Butter oil | 3932.7723 | 8.7395 | 3.9328 | 100.000 | 3.933 | 0.000 | 0.000 | 4.700 | | 0 | 0 |
| Vegetable oil | 1966.3862 | 4.3697 | 1.9664 | 100.000 | 1.966 | 0.000 | 0.000 | 0.000 | 0 | 0 | 0 |
| Whole egg mass | 3599.9872 | 8.0000 | 3.6000 | 10.250 | 0.369 | 45.000 | 1.620 | 3.000 | 0.108 | 4 | 0.144 |
| Wheat flour, 78% | 8635.0001 | 19.1889 | 8.6350 | 2.500 | 0.216 | 11.100 | 0.958 | 70.000 | 6.0445 | 15 | 1.29525 |
| Novation 2700 | 2564.8515 | 5.6997 | 2.5649 | 0.100 | 0.003 | 0.000 | 0.000 | 0.000 | 0 | 10 | 0.25649 |
| | 0.0000 | 0.0000 | 0.0000 | 0.000 | 0.000 | 0.000 | 0.000 | 0.000 | 0 | 15 | 0 |
| | 0.0000 | 0.0000 | 0.0000 | 0.000 | 0.000 | 0.000 | 0.000 | 0.000 | 0 | 2 | 0 |
| Salt in milk | 142.5870 | 0.3169 | 0.1426 | 0.000 | 0.000 | 0.000 | 0.000 | 0.000 | 0 | 0 | 0 |
| Skimmed milk | 23621.9130 | 52.4931 | 23.6219 | 3.900 | 0.921 | 3.300 | 0.780 | 4.800 | 1.13385 | 87 | 20.5511 |
| Sugar in eggs | 413.6490 | 0.9192 | 0.4136 | 0.000 | 0.000 | 0.000 | 0.000 | 100.000 | 0.41365 | 0 | 0 |
| Sugar in milk | 0.0000 | 0.0000 | 0.0000 | 0.000 | 0.000 | 0.000 | 0.000 | 100.000 | 0 | 0 | 0 |
| Freemulsion KN | 0.0000 | 0.0000 | 0.0000 | | 0.000 | | 0.000 | 100.000 | 0 | | 0 |
| Vanilla, Danisco | 0.0000 | 0.0000 | 0.0000 | 0.000 | 0.000 | 0.000 | 0.000 | 0.000 | 0 | 99 | 0 |
| U35636 | | | | | | | | | | | |
| Salt | 122.8538 | 0.2730 | 0.1229 | 0.000 | 0.000 | 0.000 | 0.000 | 0.000 | 0 | 0 | 0 |
| Total | 45000.0000 | 100.0000 | 45.0000 | 16.462 | 7.408 | 7.462 | 3.358 | 17.111 | 7.7 | 49.437 | 22.2468 |

The purpose of the experiment: 61.2326% milk products

The flour fraction

| | |
|---|---|
| Butter oil | 3.9328 |
| Vegetable oil | 1.9664 |
| Wheat flour, 78% | 8.6350 |
| Novation 2700* (starch) | 2.5649 |
| Sum | 17.0990 |

(*“Novation 2700” is a starch trademark sold from National Starch, DE.)

The milk fraction

| | |
|---|---|
| Sugar | 0.0000 |
| Skimmed milk | 23.6219 |
| Stabilizer | 0.0000 |
| Vanilla | 0.0229 |
| Total | 23.7645 |

Frying time: 1.5 min

The egg fraction

| | |
|---|---|
| Whole egg mass | 3.6000 |
| Sugar in eggs | 0.4136 |
| Salt | 0.1229 |
| Sum | 4.1365 |
| Total | 45.0000 |

Homogenizer 70/15 bars (main pressure/rear pressure)

Process:

The butter oil is melted and heated to 80° C. (Scanima). The flour and starch is added. After the addition of flour there is supplied a vacuum of up to 90%. The mixer is engaged. The mixture is kept at 60° C. for 20 min. with vacuum to evaporate water. The mixture is then heated indirectly to 110° C. The batter is subsequently cooled to 50° C. Mixer and knives are engaged.

The Milk Fraction

UHT treated directly to 142° C. for 4 sec.

Homo 70/15 bars, downstream

Is cooled to ambient temperature and pumped over to a mixing tank.

Final Batter

Correct temperature in the mixing tank is 50° C.

Add correct amount of egg/flour mix.

Cooling to 4° C.

Whipping with nitrogen and carbon dioxide.

Conclusive Evaluation:

Modified Recipe

Embodiment VII

| | | | | | 1.1 | 1 | | | | | |
|---|---|---|---|---|---|---|---|---|---|---|---|
| Ingredients | Gram | % | KG | % Fat | kg Fat | % PROT | KG PROT | % Carbo | KG KARBO | % Water | kg Water |
| Butter oil | 3450.0000 | 23.0000 | 3.4500 | 100.000 | 3.450 | 0.000 | 0.000 | 4.700 | | 0 | 0 |
| Vegetable oil | 1725.0000 | 11.5000 | 1.7250 | 100.000 | 1.725 | 0.000 | 0.000 | 0.000 | 0 | 0 | 0 |
| Wheat flour, 78% | 7575.0000 | 50.5000 | 7.5750 | 2.500 | 0.189 | 11.100 | 0.841 | 70.000 | 5.3025 | 15 | 1.13625 |
| Starch | 2250.0000 | 15.0000 | 2.2500 | 0.000 | 0.000 | 0.000 | 0.000 | 0.000 | 0 | 15 | 0.3375 |
| C [symbol] EmTex 06328 | 0.0000 | 0.0000 | 0.0000 | 0.000 | 0.000 | 0.000 | 0.000 | 0.000 | 49/53 0 | 15 | 0 |
| Total | 15000.0000 | 100.0000 | 15.0000 | 35.763 | 5.364 | 5.606 | 0.841 | 35.350 | 5.3025 | 9.825 | 1.47375 |

[symbol]

indicates data missing or illegible when filed

Embodiment VIII

| | | | | | 1.1 | 1 | | | | | |
|---|---|---|---|---|---|---|---|---|---|---|---|
| Ingredients | Gram | % | KG | % Fat | kg Fat | % PROT | KG PROT | % Carbo | kg Carbo | % Water | kg Water |
| Dem whey powder | 0.0000 | 0.0000 | 0.0000 | 0.000 | 0.000 | 0.000 | 0.000 | 0.000 | 0 | 2 | 0 |
| Salt | 180.0000 | 0.6000 | 0.1800 | 0.000 | 0.000 | 0.000 | 0.000 | 0.000 | 0 | 0 | 0 |
| Whole milk | 29820.0000 | 99.4000 | 29.8200 | 0.100 | 0.030 | 3.300 | 0.984 | 4.800 | 1.4314 | 87 | 25.94 |
| Sugar | 0.0000 | 0.0000 | 0.0000 | 0.000 | 0.000 | 0.000 | 0.000 | 100.000 | 0 | 0 | #REF! |
| Freemulsion cm3 | 0.0000 | 0.0000 | 0.0000 | | 0.000 | | 0.000 | 100.000 | 0 | | 0 |
| Vanilla lff 82.28.8042 | 0.0000 | 0.0000 | 0.0000 | 0.000 | 0.000 | 0.000 | 0.000 | 0.000 | 0 | 99 | 0 |
| Total | 30000.0000 | 100.0000 | 30.0000 | 0.099 | 0.030 | 3.280 | 0.984 | 4.771 | 1.4314 | #### | #REF! |

Embodiment IX

| | | | | | 1.1 | 1 | | | | | |
|---|---|---|---|---|---|---|---|---|---|---|---|
| Ingredients | Gram | % | KG | % Fat | kg Fat | % PROT | KG PROT | % Carbo | kg Carbo | % Water | kg Water |
| Whole egg | 16438.9923 | 87.0300 | 16.4390 | 41.000 | 6.740 | 45.000 | 7.398 | 3.000 | 0.49316977 | 4 | 0.65755969 |
| Sugar | 1888.8880 | 10.0000 | 1.8889 | 0.000 | | 0.000 | 0.000 | 100.000 | 1.888888 | 0 | 0 |
| Salt | 560.9997 | 2.9700 | 0.5610 | 0.000 | 0.000 | 0.000 | 0.000 | 0.000 | 0 | 100 | 0.56099974 |
| Total | 18888.8800 | 100.0000 | 18.8889 | 35.682 | 6.740 | 39.164 | 7.398 | 12.611 | 2.38205777 | 6.451 | 1.21855943 |

Conventional batters for pastry will in some cases require that the batter expands/swells (e.g. waffles), and this has previously been achieved by expanding substances such as baking powder, sodium bicarbonate, salt of hartshorn, etc. having been added to the batter. In ready made batters with a long shelf life may optionally, however, if the food precursor product according to the present invention is to be used for such batters, such an effect be obtained in an alternative manner. This effect is thus, according to the present invention, obtained by there to the food precursor product being added a finely dispersed inert gas such as nitrogen and/or carbon dioxide. The gas will, at the frying or heating of the product, expand and produce swelling of the product. An amount of inert gas to be added for providing such an effect, will lie within the interval 5-30% (5-30% “overrun”, i.e. there will be whipped into the batter so much gas (cold condition, 0-10° C., preferred about 4° C.) that the volume of the batter increases with 5-30%). More preferred it will be whipped inert gas into the batter corresponding to about 20% overrun.

The “overrun” in this connection is defined by the equation

(V₂−V₁)/V₁×100=percentage overrun

wherein

V₁=volume prior to whipping

V₂=volume after whipping

In connection with waffle batter there may e.g. be used an amount of carbon dioxide of 1 gram per kilo batter. Here it is, however, not relevant with any overrun since the gas dissolves into the water phase. It will also be possible to use compositions of inert gases for producing the said expanding effect. If there is used carbon dioxide in the food precursor product according to the invention, this gas will, in addition to assisting with the expansion/swelling of the product by the gas being liberated from the water in the batter when raising the temperature during frying, also assist with increasing the keeping capacity (shelf life) of the product since carbon dioxide is a bactericidal gas.

The addition of nitrogen and/or carbon dioxide by whipping into the batter may be performed with a conventional whipping/mixing device such as an aerator being suitable for industrial mousse production.

The present invention also comprises a process for producing the food precursor product being disclosed supra.

The production of food precursor products like the ones being mentioned supra, e.g. batters, may be separated into three phases and five steps:

| Phase 1 | Phase 2 | Phase 3 | |
|---|---|---|---|
| Flour/oil | Eggs | Milk/liquid | Step 1 |

| | |
|---|---|
| [symbol] | |
| Mixing of | Step 2 |
| the phases | |
| [symbol] | |
| Homogenizing | Step 3 |
| and cooling | |
| [symbol] | |
| Inclusion of | Step 4 |
| gases by whipping/ | |
| injection | |
| [symbol] | |
| Emptying into | Step 5 |
| containers | |

The three phases in step 1 are produced in parallel, whereas the steps from 1 to 5 are performed chronologically. In those products where egg is not used, the egg phase (phase 2) will simply be omitted from the process.

This process line will make it possible to produce liquid food precursor products such as sauces, thickeners and batters with a shelving lifetime of at least 6 weeks in a refrigerated state at 0 to 4° C.

Disclosure of the Process:

Step 1.

Phase 1: The Flour/Oil Phase.

In this phase the starch will be sterilized without destroying its capacity to bind water.

The starch is heat treated in water-free oil at a time/temperature combination that is able to kill vegetative microorganisms and spore producers so that the final product obtains a storage capacity of at least 6 weeks when refrigerated. A heat treatment of e.g. 110° C. for 5 minutes is sufficient.

An important detail in the sterilizing of the flour phase is that the first part of heating (up to 60° C.) is performed under vacuum. This is done because the starch contains up to 15% water which is to be removed before the relevant polysaccharides reach their swelling point.

After the heating phase 1 needs to be cooled to below 50° C. before it is mixed with the other phases in step 2. This is important for preventing the starch from swelling. Normally, the relevant substances will not swell before they reach 60°, but the present heating process changes the properties of the starch.

Polysaccharides that may be used are inter alia wheat starch and tapioca starch.

Relevant types of oils are vegetable oils such as butter oil, soy oil, rape seed oil, sunflower oil, olive oil, etc., animal oils, e.g. marine oils such as cod liver oil (omega-3 very long chain polyunsaturated fatty acids) etc.

Phase 2: Eggs.

This phase may be omitted if there is to be produced food precursor products without any addition of eggs (allergy-safe products, gravy, etc.). If this phase is present, the egg phase is heated to the extent that the bacteria content becomes so reduced that the mixture obtains a shelving lifetime of at least 6 weeks under refrigerated conditions. The heat treatment is still not so extensive that the proteins congeal. A trick is here to add some sugar to the egg material. This protects the proteins somewhat so that it is possible to raise the treatment temperature to a degree over what a person skilled in the art might expect. In the present invention there has been used up to about 10% sugar. A typical heat load is 70° C. for 90 seconds. After this heat treatment phase 2 needs to be cooled to below 50° C. before it is added to the other phases in step 2. To obtain a satisfactory bacteriology in the egg phase, the processing equipment should be designed as a UHT-plant (ultra-high temperature plant). A UHT-plant is used conventionally within the art and provides a heat treatment that is sufficiently strong for the product to become substantially sterile. In a UHT-plant the equipment will also after the heat treatment be designed in such a way that reinfection of the product is avoided. This is relevant for all the parts that come into contact with the product such as piping, valve arrangements, homogenizer, intermediate storage tanks, draining machine, gas- and gas supply equipment as well as sterilizing of the containers.

Phase 3: Milk.

The milk phase contains, in addition to milk, also taste elements and stabilizers that make it possible to produce a mousse from the composition obtained in step 2. The is milk phase is given a heat treatment sufficient to provide a shelf lifetime to this phase also of at least 6 weeks. There has e.g. been used 110° C. for 2.5 min.

Step 2.

In step 2 the three phases are mixed to form a product with a prolonged shelving lifetime such as (waffle) batter. The temperature in the mixture must lie above the melting point of the oil/fat, but below the swelling point of the polysaccharides.

Step 3.

In step 3 the batter is homogenized and cooled to the relevant storing temperature, normally 0 to 4° C.

The correct homogenizing pressure is important. It must not be so high that the oil/fat becomes bound too tightly to the proteins. Usable pressures lie conveniently below 70 bars. If the pressure becomes too high the batter may e.g. adhere by charring to the waffle iron/frying pan during frying.

Step 4.

This step may be omitted if it is preferred an end product wherein it is not necessary that the product swells. In those products that require swelling during frying (e.g. waffle batter) there is added inert gas (e.g. nitrogen or carbon dioxide). The amount of gas depends on how much the product is to swell. For waffles a 20% overrun is suitable. In addition to an inert gas or as a substitute to an inert gas, carbon dioxide is added to ensure an improved bacteriological keeping capacity. A suitable amount is about 1 gram gas per kilo product.

Step 5.

It is important for the product that it is packed in a container/enclosure with good gas barrier properties. An important parameter is the resistance of the container/enclosure against penetration of carbon dioxide and oxygen. Selection of such materials lies within the purview of the person skilled in the art. Examples of such materials are laminated plastics (polyethylene, polyvinyl, polystyrene, EVOH, etc.) optionally layered internally with a metal foil, e.g. aluminum.

It is preferred that the product according to the invention is filled into the container/enclosure to 100% of its volume. If, however, there is used a lower filling ratio of the container/enclosure where a headspace is required, the oxygen content must then not exceed 3% in the gas pocket above the batter. This means that the product should be flushed with inert gas and optionally carbon dioxide.

A container/enclosure with poor oxygen barrier properties, or if there is too much oxygen in the head space gives a discoloration of the batter (it becomes gray), whereas a poor carbon dioxide barrier makes this gas disappear from the batter during storage. This lessens the keeping capacity of the batter.

What is claimed is:

1. Process for producing a food precursor product comprising
(a) a portion of polysaccharides within the interval 3-50%, more preferred 10-50%, even more preferred 30-45%, most preferred 35-42%, especially 38-40% calculated on the weight of the end product;
(b) a portion of fat/oil within the interval 3-20%, more preferred 5-15%, even more preferred 7-13%, e.g. 8% calculated on the weight of the end product;
(c) a portion of eggs and/or an egg fraction within the interval 0-15%, preferred 5-10%, e.g. 8% calculated on the weight of the end product;
(d) a portion of fluid in the form of water and/or a milk fraction and/or milk product wherein this fluid represents the balance of the food precursor product up to 100% calculated on the weight of the end product,
wherein the water activity of the food precursor product exceeds 95% and wherein the food precursor product has entrained carbon dioxide as a swelling and antibacterial component;
wherein
(i) the ingredients under section (a) are heated in the ingredients from section (b) in a temperature interval of 50-150° C., more preferred 90-110° C., e.g. 105° C. for a time interval being sufficient to sterilize the composition by removing/killing microorganisms to produce a first phase with a sufficiently low bacterial count, e.g. for a time interval of 1-15 minutes, more preferred 1-7 minutes, e.g. 5 minutes;
(ii) the ingredients under section (d) are heat treated at a temperature and for a time interval which does not denature the proteins in this material;
whereafter the two phases (i) and (ii) are mixed mechanically with each other at a temperature that lies above the melting point of the fat/oil, but below the swelling point of the polysaccharides, homogenized to a homogenous composition and cooled to below 15° C., preferred 0-4° C., and the resulting homogenate is added a bactericidal and/or inert gas for producing a fluid/semi-fluid product in the form of a mousse.

2. The process for producing a food precursor product according to claim 1, wherein phase (i) and (ii) is added a further phase (iii) comprising the ingredients under section (c) and which is heat treated at a temperature and for a time interval that does not destroy the proteins in this material, whereafter the material is brought to a temperature below 50° C. for producing a second phase.

3. The process for producing a food precursor product according to claim 1, wherein the end product is filled into a container/enclosure comprising a gas barrier, especially a gas barrier being effective towards carbon dioxide and oxygen.

4. The process for producing a food precursor product according to claim 3, wherein the end product is filled completely (100%) into the container/enclosure.

5. The process for producing a food precursor product according to claim 3, wherein the end product is filled in a contained/enclosure with a “headspace”, the oxygen content in the gas composition over the end product not exceeding 3%, and preferably wherein the gas composition over the end product comprising an inert gas, optionally carbon dioxide, with an oxygen content not exceeding 3%.

6. The process for producing a food precursor product according claim 1, wherein the inert gas is nitrogen.

7. The process for producing a food precursor product according to claim 1, wherein carbon dioxide is filled into the product and/or the container/enclosure as a bactericidal gas.

8. The process for producing a food precursor product according to claim 1, wherein the heating of the polysaccharides in phase (i) is done in two steps, wherein the heating of the polysaccharides up to 60° C. is done under vacuum for removing possible water in the polysaccharide section.

9. The process for producing a food precursor product according to claim 1, wherein the heating of the proteins in phase (ii) is done at the addition of sugar, e.g. 10% sugar.
